(19) United States
(12) Patent Application Publication
(10) Pub. No.: US 2018/0019647 A1
(43) Pub. Date: Jan. 18, 2018

(54) DIRECT-CURRENT COMMUTATOR MOTOR

(71) Applicant: MITSUBISHI HEAVY INDUSTRIES AUTOMOTIVE THERMAL SYSTEMS CO., LTD., Kiyosu-shi, Aichi (JP)

(72) Inventors: Atsushi SUZUKI, Kiyosu-shi (JP); Yasuhiro WATANABE, Kiyosu-shi (JP); Kenichi TERAUCHI, Kiyosu-shi (JP)

(73) Assignee: MITSUBISHI HEAVY INDUSTRIES AUTOMOTIVE THERMAL SYSTEMS CO., LTD., Kiyosu-shi, Aichi (JP)

(21) Appl. No.: 15/546,436

(22) PCT Filed: Jan. 5, 2016
(86) PCT No.: PCT/JP2016/050116

§ 371 Date: Jul. 26, 2017

(30) Foreign Application Priority Data
Jan. 28, 2015 (JP) 2015-014441

(51) Int. Cl. H02K 13/00; H02K 13/10; H02K 13/04

(52) U.S. Cl. CPC H02K 13/006; H02K 13/04; H02K 13/10

(57) ABSTRACT

A direct-current commutator motor includes a stator section having a magnet; a rotor section which is rotatably provided in the stator section and has a coil configured to generate a magnetic field by being energized; a commutator which has a plurality of terminal sections provided on an outer circumferential surface at intervals in a circumferential direction and rotates together with the rotor section to energize the coil; a brush which is pressed against and comes into contact with the commutator, is supported by the stator section, and relatively rotates with respect to the commutator; and a pigtail provided in the brush to transmit an electric current supplied from the outside to the brush. The brush is provided with a through-hole extending along a direction in which a rotary shaft of the rotor section extends.

### TECHNICAL FIELD

The present invention relates to a direct-current commutator motor.

Priority is claimed on Japanese Patent Application No. 2015-014441, filed Jan. 28, 2015, the content of which is incorporated herein by reference.

### BACKGROUND ART

A direct-current commutator motor used for components and the like of an automobile includes a commutator and a brush pressed against an outer circumferential surface of the commutator to supply power to a coil of a rotor. The commutator is provided integrally with a rotary shaft of the rotor and rotates together with the rotary shaft. Current is supplied to a brush from a power feeding source. When a front end portion of the brush is pressed against the outer circumferential surface of the commutator that rotates integrally with the rotor, the brush and the commutator are electrically connected to each other.

Since the brush slides against the outer circumferential surface of the rotating commutator, its front end portion gradually wears. If the brush becomes completely worn, since the direct-current commutator motor will not operate, the brush needs to be replaced at an appropriate timing.

Thus, Patent Literature 1 discloses a configuration in which a striking sound generating portion or a sliding sound generating portion which generates a sound when the brush becomes worn is provided at a proximal end portion of the brush. The striking sound generating portion is formed by making the proximal end portion of the brush thinner than the front end portion side of the brush. When the brush is worn, the brush moves in a brush holder holding the brush, and the brush collides with the brush holder, the striking sound generating portion generates a striking sound. Further, the sliding sound generating portion is formed of a material different from the proximal end portion of the brush at the proximal end portion of the brush. When the brush is worn, the sliding sound generating portion begins to slide on the commutator, which makes the sliding sound louder than in a case where only the brush comes into contact with the commutator.

According to the invention described in Patent Literature 1, with such a configuration, it is possible to exchange the brush, by detecting the occurrence of the striking sound or the sliding sound due to wear of the brush having progressed.

### CITATION LIST

### Patent Literature

### [Patent Literature 1]

Japanese Unexamined Patent Application, First Publication No. 2009-124788

### SUMMARY OF INVENTION

### Technical Problem

However, in the configuration disclosed in Patent Literature 1, when forming the striking sound generating portion by making the proximal end portion of the brush thinner than the front end portion side, it is necessary to machine a mold for forming the brush, which incurs costs.

In addition, in order to form the sliding sound generating portion, it is necessary to prepare a member different from the material of the brush, which also incurs costs.

An object of the present invention is to provide a direct-current commutator motor that can detect the wear of a brush at a lower cost with a simple structure.

### Solution to Problem

According to a first aspect of the present invention, there is provided a direct-current commutator motor including a stator section having a magnet; a rotor section which is rotatably provided in the stator section and has a coil configured to generate a magnetic field by being energized; a commutator which has a plurality of terminal sections provided on an outer circumferential surface at intervals in a circumferential direction and rotates together with the rotor section to energize the coil; a brush which is pressed against the commutator to come into contact with the terminal section, is supported by the stator section, and relatively rotates with respect to the commutator; and a pigtail provided on the brush to transmit an electric current supplied from the outside to the brush, wherein the brush is provided with a hollow section extending along a direction in which a rotary shaft of the rotor section extends.

According to such a configuration, when the front end portion of the brush slides while relatively rotating with respect to the commutator, the end portion in the circumferential direction of the terminal section provided on the surface of the commutator and the end portion in the circumferential direction of the front end portion of the brush hit against each other to generate a sound. Further, when the brush is worn by sliding on the terminal section and the hollow section is exposed to the front end portion of the brush, in addition to the hitting sound generated between the front end portion of the brush and the terminal section, a sound is generated even when the end edge (the edge on the commutator side) on the inner circumferential surface of the hollow section hits against the end portion of the terminal section in the circumferential direction. That is, when the brush is worn and the hollow section is exposed, the number of occurrences of contact sounds generated by hitting between the brush and the terminal section increases, and the frequency of the sound at the time of sliding of the brush and the terminal section changes. Accordingly, the wear of the brush can be detected.

According to a second aspect of the present invention, in the first aspect, a shape of a cross-section of the hollow section intersecting with a direction in which the rotary shaft extends may have a circular shape.

Since the hollow section can be easily formed in the brush by a working machine such as a drill, increase in costs can be minimized.

In a third aspect of the present invention, in the first aspect, a shape of a cross-section of the hollow section intersecting with a direction in which the rotary shaft extends may have a quadrangular shape.

When exposed to the front end portion of the brush, two end edges on the inner circumferential surface of the hollow section are formed for a single hollow section. Further, a contact sound between each end edge of the hollow section and the terminal section is generated twice per a hollow section. Here, since the cross section of the hollow section has a quadrangular shape, even when the hollow section starts to be exposed, the distance between the two end edges of the hollow section can be ensured. Therefore, it is easy to hear the contact sound twice, and it is easy to detect the change in the frequency of the sound when the brush and the terminal section slide.

In a fourth aspect of the present invention, in the first to third aspects, a plurality of the hollow sections may be provided at intervals in the circumferential direction of the commutator.

With such a configuration, if the brush is worn by sliding on the terminal section, when the hollow section is exposed to the front end portion of the brush, the number of occurrences of the contact sound when the end edge of the hollow section hits against the terminal section increases. As a result, a change of the frequency of the sound becomes large when the brush and the terminal section slide.

According to a fifth aspect of the present invention, in the first to fourth aspects, the brush may be provided with a different material portion formed of a material different from the material forming the brush, at an end portion opposite to an end portion on a side facing the commutator.

With such a configuration, when the brush is worn by sliding on the terminal section, if the different material portion starts to come into contact with the terminal section, the sound when the brush and the terminal section slide changes. This also makes it possible to detect the wear of the brush.

According to a sixth aspect of the present invention, in the fifth aspect, the different material portion may be the pigtail.

It is not necessary to prepare a special member as the different material portion and it is possible to change the sound when the brush and the terminal section slide, using the pigtail as it is. Therefore, it is possible to minimize the material costs and the manufacturing costs.

According to a seventh aspect of the present invention, in the sixth aspect, at least a front end portion of the pigtail on the commutator side may be provided to extend in a direction in which the brush is pressed toward the commutator.

Also, if the front end portion of the pigtail comes into contact with the terminal section and wear of the front end portion has progressed together with the brush, it is possible to reliably achieve energization of the brush from the pigtail.

According to an eighth aspect of the present invention, in the seventh aspect, the hollow section and the front end portion of the pigtail may be provided at intervals in a direction in which the brush is pressed toward the commutator.

When the brush becomes worn, there are three states which are a state in which the end edge of the hollow portion comes into contact with the terminal section, a state in which the pigtail slides against the terminal sections, and a state in which only a portion of the brushes having no through-holes formed therein slides against the terminal sections. As a result, the frequency of the sound when the brush slides against the terminal section changes in a plurality of stages.

### Advantageous Effects of Invention

According to this direct-current commutator motor, by using a brush in which a hollow section is formed, it is possible to detect wear of the brush with a simple structure at a lower cost.

### BRIEF DESCRIPTION OF DRAWINGS

FIG. 1 is a cross-sectional view illustrating an overall configuration of a direct-current commutator motor according to an embodiment of the present invention.

FIG. 2 is a cross-sectional view of a brush of the direct-current commutator motor according to the first embodiment as viewed from a direction orthogonal to an axial direction of a rotary shaft.

FIG. 3 is a cross-sectional view illustrating a state in which the brush illustrated in FIG. 2 is worn.

FIG. 4 is a cross-sectional view of a brush of a direct-current commutator motor according to a modified example of the first embodiment as viewed from a direction orthogonal to the axial direction of the rotary shaft.

FIG. 5 is a cross-sectional view illustrating a state in which the brush illustrated in FIG. 4 is worn.

FIG. 6 is a side view illustrating a brush of a direct-current commutator motor according to a second embodiment.

FIG. 7 is a diagram illustrating a configuration of a first modified example of the brush of the second embodiment.

FIG. 8 is a diagram illustrating a configuration of a second modified example of the brush of the second embodiment.

FIG. 9 is a diagram illustrating a configuration of a third modified example of the brush of the second embodiment.

### DESCRIPTION OF EMBODIMENTS

Hereinafter, a direct-current commutator motor according to an embodiment of the present invention will be described with reference to the drawings.

### First Embodiment

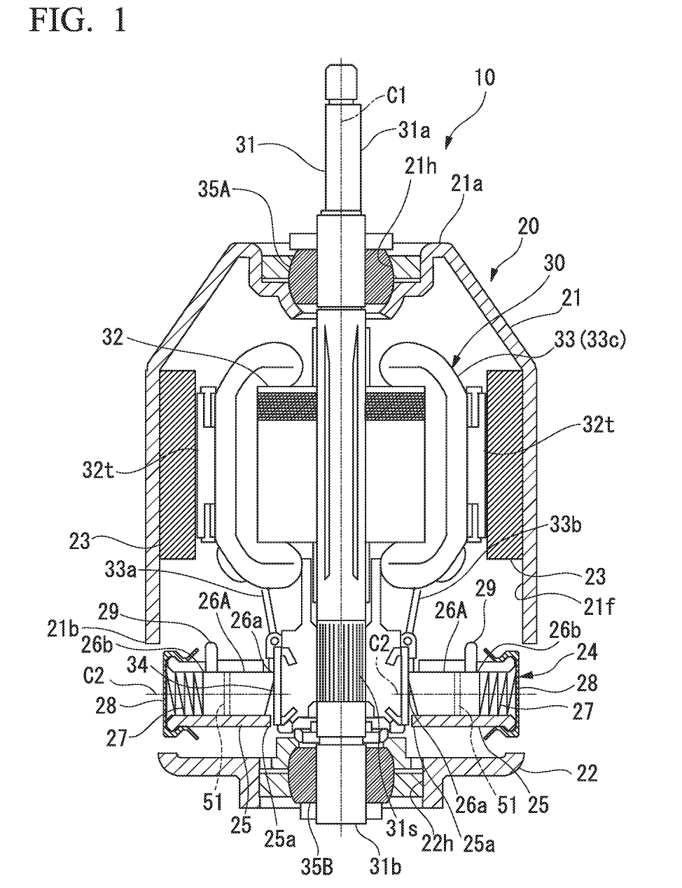

As illustrated in FIG. 1, a direct-current commutator motor 10 of this embodiment is used, for example, as a blower motor which feeds conditioned air into an interior of an automobile in an air conditioner system of the automobile.

The direct-current commutator motor 10 includes a stator section 20 and a rotor section 30.

The stator section 20 includes a tubular yoke 21, a lid body 22, a magnet 23, and a brush unit 24.

The yoke 21 has a cylindrical shape. One end side of the yoke 21 is a closed end 21a, and the other end side of the yoke 21 is an open end 21b which is open.

A shaft insertion hole 21h is formed in the central portion of the closed end 21a.

The lid body 22 has a substantially disk shape and is disposed to face the open end 21b of the yoke 21. A shaft insertion hole 22h is formed in the central portion of the lid body 22.

The magnet 23 is fixed to an inner circumferential surface 21f of the yoke 21. The magnet 23 has an arcuate cross-section along the inner circumferential surface 21f of the yoke 21. A plurality of magnets 23 are provided on the inner circumferential surface 21f of the yoke 21 at intervals in the circumferential direction along the circumferential direction.

The brush unit 24 is supported on the yoke 21 via a frame (not illustrated). The brush unit 24 includes a brush holder 25, a brush 26A, a brush spring 27, and a spring stopper 28.

The brush holder 25 is fixed to a frame (not illustrated). The brush holder 25 has a substantially tubular shape, and stores a brush 26A and a brush spring 27 therein. A plurality of brush holders 25 are provided in the circumferential direction with respect to a central axis C1 of the yoke 21. The respective brush holders 25 are provided radially with respect to the central axis C1 of the yoke 21. End portions 25a on the inner circumference side of the brush holder 25 are disposed on the commutator 34 to be described later at intervals in the circumferential direction of the yoke 21 facing in a radial direction of the yoke 21.

The brush 26A is formed of carbon. The brush 26A is stored in the brush holder 25. The brush 26A is freely movable forward and backward with respect to the commutator 34 to be described later along an axial direction C2 of the brush holder 25. The front end portion 26a of the brush 26A is formed in a wedge shape in which a cross-sectional area gradually decreases toward the front end.

A pigtail 29 formed of a copper wire or the like is provided in a rear end portion 26b side of the brush 26A. In the brush 26A, the pigtail 29 extends in a direction intersecting with the axial direction C2 of the brush holder 25, that is, toward the closed end 21a of the yoke 21 to protrude outward from the brush 26A. Power is supplied to the pigtail 29 from a power feeding source such as a battery and a generator through a power feeding line.

The brush spring 27 is an elastic member that presses the brush 26A toward the central axis C1 of the yoke 21. A spring stopper 28 is attached to an end portion of the brush holder 25 facing the outer circumferential side of the yoke 21. The brush spring 27 is provided between the brush 26A and the spring stopper 28 in a compressed state.

The rotor section 30 includes a rotary shaft 31, a core 32, a coil 33, and a commutator 34.

The rotary shaft 31 is disposed coaxially with the central axis C1 of the yoke 21. One end portion 31a of the rotary shaft 31 is rotatably held in a shaft insertion hole 21h formed in the yoke 21 via a bearing 35A. The other end portion 31b of the rotary shaft 31 is rotatably held in a shaft insertion hole 22h formed in the lid body 22 via a bearing 35B.

One end portion 31a of the rotary shaft 31 protrudes outward from the yoke 21 and is connected to a blower fan (not illustrated) or the like.

The core 32 is disposed inside the yoke 21 and is formed by laminating a large number of electromagnetic steel plates along the axial direction in which the rotary shaft 31 extends.

A plurality of teeth 32t are formed in the outer circumferential portion of the core 32 in the circumferential direction.

The coil 33 is formed by winding the coil wire 33c around the teeth 32t of the core 32 many times. Both ends 33a and 33b of the coil wire 33c are connected to the commutator 34.

The commutator 34 is provided at a position on the rotary shaft 31 different from that of the core 32 in the axial direction of the rotary shaft 31. Specifically, the commutator 34 is provided between the bearing 35B and the core 32. The commutator 34 has a substantially cylindrical shape, and is engaged with a spline 31s formed on the outer circumferential surface of the rotary shaft 31 to rotate integrally with the rotary shaft 31.

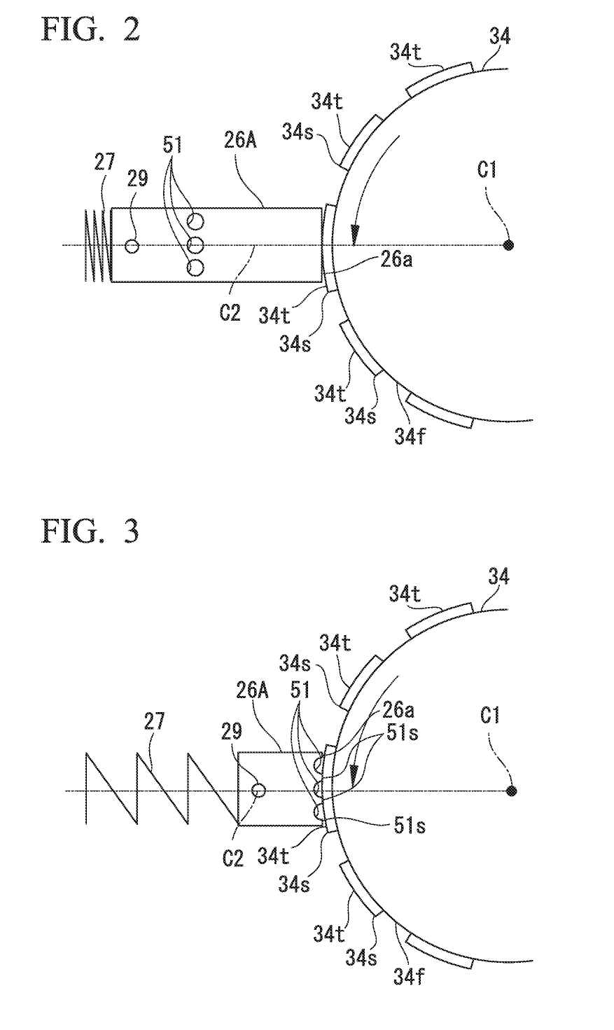

As illustrated in FIG. 2, on the outer circumferential surface of the commutator 34, a plurality of terminal sections 34t are provided at intervals in the circumferential direction. Each terminal section 34t is provided to protrude slightly toward the outer circumferential side from the outer circumferential surface 34f of the commutator 34.

In such a direct-current commutator motor 10, a power feeding source line (not illustrated) connected to the power feeding source is connected to the pigtail 29 to supply a current from the power feeding source (not illustrated). Then, the current is supplied to the coil 33 from the pigtail 29 through the brush 26A, via the terminal section 34t of the commutator 34 on which the front end portion of the brush 26A slides. The rotor section 30 of the direct-current commutator motor 10 is rotationally driven by the interaction between the magnetic field generated by the coil 33 and the magnetic field of the magnet 23 of the stator section 20.

A through-hole (hollow section) 51 is formed in the brush 26A of the direct-current commutator motor 10. A cross-sectional shape of the through-hole 51 orthogonal to the central axis C1 is a circular shape (a perfect circle shape in the present embodiment). Further, the through-hole 51 may be continuously formed in the brush 26A in a direction parallel to the central axis C1 of the yoke 21. Furthermore, a plurality of through-holes 51 may be formed at intervals along the circumferential direction of the commutator 34. In the present embodiment, three through-holes 51 are formed for each brush 26A.

The through-hole 51 may be formed along the direction of the central axis C1 of the yoke 21, and may be formed in a direction inclined with respect to the direction of the central axis C1, without being necessarily parallel to the central axis C1. Further, the respective through-holes 51 may be formed at positions deviated in the radial direction of the commutator 34. Further, only one through-hole 51 may be formed for a single brush 26A.

Since the brush 26A slides on the outer circumferential surface of the commutator 34 rotating integrally with the rotary shaft 31, the front end portion 26a is worn. When the brush 26A is worn, its entire length becomes short. However, since the brush 26A is pushed to the front end portion 26a side by the brush spring 27, the brush 26A is gradually pushed toward the commutator 34 side inside the brush holder 25.

The brush 26A pressed by the brush spring 27 generates a sound when the front end portion 26a comes into contact with the corner section 34s (the end portion in the circumferential direction) of the terminal section 34t of the commutator 34. Therefore, when the rotary shaft 31 rotates at a constant rotation speed, a contact sound between the brush 26A and the terminal section 34t of the commutator 34 is periodically generated.

As illustrated in FIG. 3, when the wear of the brush 26A progresses and the through-hole 51 is exposed, the end portion 51s of the through-hole 51 (the end edge on the inner circumferential surface) of the brush 26A also comes into contact with the terminal section 34t of the commutator 34. As a result, the number of contacts between the brush 26A and the terminal section 34t of the commutator 34 during one rotation of the rotary shaft 31 increases. Thus, the frequency of the sliding sound between the brush 26A and the terminal section 34t increases.

The user can maintain the direct-current commutator motor 10 at an appropriate timing, by detecting that the frequency of the sound generated by the direct-current commutator motor 10 increases when the wear of the brush 26A progresses in this way.

Here, since the cross-sectional shape of the through-hole 51 is a circular shape, when the brush 26A is worn and the portion of the through-hole 51 slides between the terminal sections 34t as described later, it is possible to suppress the occurrence of cracks or the like with the inner circumferential surface of the through-hole 51 as a base point due to the stress generated by pressing the brush 26A against the commutator 34.

In addition, since the cross-sectional shape of the through-hole 51 is a circular shape, the through-hole 51 can be easily formed in the brush 26A by a working machine such as a drill, and cost increase can be suppressed.

Therefore, it is possible to reliably detect the wear of the brush 26A at a lower cost.

In addition, a plurality of through-holes 51 are formed on the outer circumferential side of the commutator 34 at intervals in the circumferential direction of the commutator 34. With such a configuration, when the through-hole 51 is exposed to the front end portion 26a of the brush 26A, the number of occurrence of the contact sound at the time of hitting of the end portion 51s of the through-hole 51 against the terminal section 34t in the brush 26A increases. As a result, a frequency of the sound at the time of sliding of the brush 26A against the terminal section 34t changes by increasing. As a result, it is possible to sufficiently detect the wear of the brush 26A.

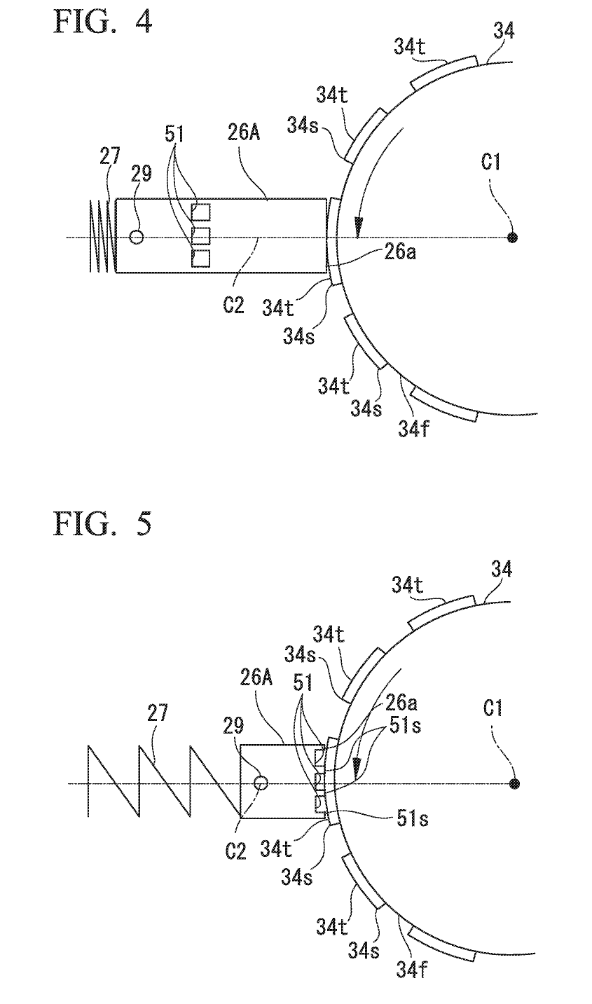

Here, in the present embodiment, the cross-sectional shape of the through-hole 51 may be a circular shape, a quadrangular shape, other polygonal shapes, and the like. FIGS. 4 and 5 illustrate a case where the cross-sectional shape of the through-hole 51 is a quadrangular shape, specifically, a case where, when viewed from the direction of the central axis C1, the opposing two sides of the quadrangle are formed to be parallel to the axial direction C2, and the other opposing two sides are formed to be orthogonal to the axial direction C2.

In this case, when the through-hole 51 is exposed to the front end portion of the brush 26A, even when the through-hole 51 starts to be exposed, as compared to a case of a circular cross-sectional shape, it is possible to secure a large distance between the two end portions 51s of the through-hole 51. Therefore, it is easy to hear the contact sound twice at the end portion 51s, and it is easy to detect the change in the frequency of the sound when the brush 26A against the terminal section 34t slide.

### Second Embodiment

Next, a second embodiment of the direct-current commutator motor according to the present invention will be described. In the second embodiment described below, since only the configuration of the brush 26B is different from that of the first embodiment, parts the same as those of the first embodiment are denoted by the same reference numerals, and repeated description will not be provided.

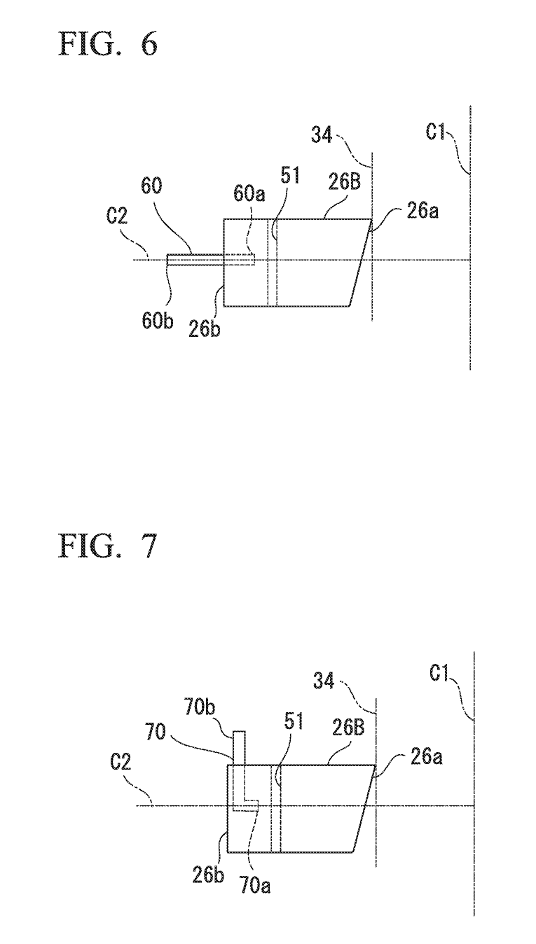

FIG. 6 is a schematic diagram illustrating a configuration of a brush in the second embodiment of the direct-current commutator motor.

As illustrated in FIG. 6, a brush 26B included in the direct-current commutator motor 10 in this embodiment is formed of carbon, similarly to the brush 26A described in the first embodiment.

A through-hole 51 is formed in the brush 26B. As in the first embodiment, a plurality of through-holes 51 may be formed at intervals in the circumferential direction of the commutator 34.

In addition, the cross-sectional shape of the through-hole 51 may be a circular shape, a quadrangular shape, other polygonal shapes, or the like.

On the rear end portion 26b side of the brush 26B, a pigtail (different material portion) 60 formed of a copper wire or the like is provided. The pigtail 60 extends in the axial direction C2 of the brush holder 25. One end 60a of the pigtail 60 is embedded in the brush 26 B, and the other end 60b of the pigtail 60 protrudes from the rear end portion 26b of the brush 26B. Here, one end 60a of the pigtail 60 is located on the side away from the commutator 34 compared with the through-hole 51 at intervals. Power is supplied to the pig tail 60 from a power feeding source such as a battery and a generator through a power feeding line.

In such a brush 26B, the front end portion 26a is worn by sliding against the terminal section 34t integrally rotating with rotary shaft 31.

When the wear of the brush 26B progresses and the through-hole 51 is exposed, since the end portion 51s (see FIG. 3) of the through-hole 51 in the brush 26B also comes into contact with the terminal section 34t of the commutator 34, the frequency of the sliding sound between the brush 26B and the terminal section 34t increases.

When the wear of the brush 26B further progresses and passes through the portion in which the through-hole 51 of the brush 26B is formed, the brush 26B comes into contact with the terminal section 34t of the commutator 34 only at the portion in which the through-hole 51 of the brush 26B is not formed. As a result, the frequency of the sliding sound between the brush 2613 and the terminal section 34t decreases.

Further, when the wear of the brush 26B progresses and the one end 60a of the pigtail 60 starts to come into contact with the terminal section 34t, since the pigtail 60 is formed of a material harder than the brush 26B, the frequency of the sliding sound between the brush 26B and the terminal section 34t increases.

The user can maintain the direct-current commutator motor 10 at an appropriate timing, by detecting the change in the frequency of the sound generated from the direct-current commutator motor 10 when the wear of the brush 26B progresses in this manner.

Therefore, according to the direct-current commutator motor 10 of the aforementioned second embodiment, similarly to the aforementioned first embodiment, when the brush 26B is worn and the through-hole 51 is exposed, since the frequency of the sound at the time of sliding of the brush 26B and the terminal section 34t changes, the wear of the brush 26B can be detected.

Further, by providing the pigtail 60 as a different material portion formed of a material different from the forming material of the brush 26B on the rear end portion 26b on the opposite side to the front end portion 26a on the side facing the commutator 34, the wear of the brush 26B can be detected. As a result, it is possible to sufficiently detect the wear of the brush 26B.

Further, by using the pigtail 60, there is no need to prepare a special member as a different material portion, and the material cost can be suppressed.

The pigtail 60 is provided to extend in the axial direction C2, which is a direction in which the brush 26B is pressed toward the outer circumferential surface of the commutator 34. With such a configuration, even when the pigtail 60 comes into contact with the terminal section 34t and the wear of the pigtail 60 together with the brush 26B progresses, the energization from the pigtail 60 to the brush 26B can be reliably achieved.

Furthermore, in the direct-current commutator motor 10, the through-hole 51 and one end 60a of the pigtail 60 are provided at intervals in the axial direction C2. Therefore, when the brush 26B is worn, there are three states, that is, a state in which the end portion 51s of the through-hole 51 comes into contact with the terminal section 34t, a state in which only the brush 26B of a portion having no through-hole 51 formed therein slides against the terminal sections 34t, and a state in which the pigtail 60 slides against the terminal sections 34t. As a result, the frequency of the sound when the brush 26B and the terminal section 34t slide changes in a plurality of stages.

As described above, the direct-current commutator motor 10 of this embodiment makes it possible to sufficiently detect the wear of the brush 26B.

Here, in the second embodiment, the pigtail 60 is formed to extend in the axial direction C2 of the brush holder 25, but it is not limited thereto.

FIG. 7 is a diagram illustrating a configuration of a first modified example of the brush of the second embodiment.

As illustrated in FIG. 7, the pigtail (different material portion) 70 is bent, for example, in an L shape, one end 70a of the pigtail 70 extends in the axial direction C2 of the brush holder 25 and is embedded in the brush 26B, and the other end 70b of the pigtail 70 may extend in a direction orthogonal to the axial direction C2 of the brush holder 25 and may protrude outward from the brush holder 25.

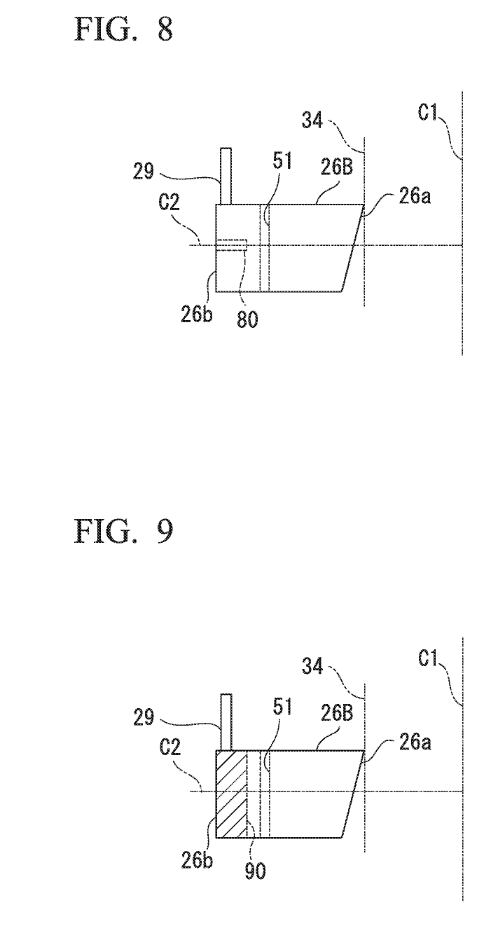

Further, FIG. 8 is a diagram illustrating a configuration of a second modified example of the brush of the second embodiment.

As illustrated in FIG. 8, as the different material portion 80 which is a member separate from the pigtail 29, a member formed of a material different from the material forming the brush 26B may be provided to be embedded in the brush 26B from the end portion on the opposite side to the end portion of the side facing the commutator 34. In the example of FIG. 8, the different material portion 80 is inserted into the brush 26B at a substantially central position in the direction of the central axis C1 of the brush 26B.

Further, FIG. 9 is a view illustrating a configuration of a third modified example of the brush of the second embodiment.

As illustrated in FIG. 9, as a different material portion 90 which is a separate member from the pigtail 29, a member formed of a material different from the material forming the brush 26C is attached to the brush 26C from the end portion on the opposite side to the end portion of the side facing the commutator 34.

The present invention is not limited to the above-described embodiments, and includes various modifications to the aforementioned embodiments within the scope that does not depart from the gist of the present invention. That is, the specific forms, configurations, and the like described in the embodiments are merely examples, and can be appropriately changed.

For example, in each of the embodiments and its modified examples, the through-hole 51 is formed as a hollow section. However, a recessed portion that does not penetrate the brushes 26A, 26B, and 26C instead of the through-hole 51 may be formed as the hollow section.

For example, the overall configuration of the direct-current commutator motor 10 may have any configuration.

Further, the application of the direct-current commutator motor 10 may be to anything.

Further, the configurations of the aforementioned embodiment and modified examples may be combined as appropriate.

### INDUSTRIAL APPLICABILITY

According to the aforementioned direct-current commutator motor, by using a brush having a hollow section, the wear of the brush can be detected with a simple structure at a lower cost.

### REFERENCE SIGNS LIST

10 Direct-current commutator motor

20 Stator section

21 Yoke

21a Closed end

21b Open end

21f Inner circumferential surface

21h Shaft insertion hole

22 Lid body

22h Shaft insertion hole

23 Magnet

24 Brush unit

25 Brush holder

25a End portion

26A, 26B, 26C Brush

26a Front end portion

26b Rear end portion

27 Brush Spring

28 Spring stopper

29 Pigtail

30 Rotor section

31 Rotary shaft

31a One end portion

31b Other end portion

31s Spline

32 Core

32t Teeth

33 Coil

33c Coil wire

34 Commutator

34f Outer circumferential surface

34s Corner section

34t Terminal

35A Bearing

35B Bearing

51 Through-hole (hollow section)

51s End portion

60 Pigtail (different material portion)

60a One end

60b The other end

70 Pigtail (different material portion)

70a One end

70b The other end

80 Different material portion

90 Different material portion

C1 Central axis

C2 Axial direction

1-8. (canceled)

9. A direct-current commutator motor comprising:
a stator section having a magnet;
a rotor section which is rotatably provided in the stator section and has a coil configured to generate a magnetic field by being energized;
a commutator which has a plurality of terminal sections provided on an outer circumferential surface at intervals in a circumferential direction and rotates together with the rotor section to energize the coil;
a brush which is pressed against the commutator to come into contact with the terminal section, is supported by the stator section and relatively rotates with respect to the commutator; and
a pigtail provided on the brush to transmit an electric current supplied from the outside to the brush,
wherein the brush is provided with a hollow section extending along a direction in which a rotary shaft of the rotor section extends,
the brush is provided with a different material portion formed of a material different from the material forming the brush at an end portion opposite to an end portion on a side facing the commutator, and
the hollow section and the different material portion are provided at intervals in a direction in which the brush is pressed toward the commutator.

10. The direct-current commutator motor according to claim 9, wherein a shape of a cross-section of the hollow section intersecting with a direction in which the rotary shaft extends has a circular shape.

11. The direct-current commutator motor according to claim 9, wherein a shape of a cross-section of the hollow section intersecting with a direction in which the rotary shaft extends has a quadrangular shape.

12. The direct-current commutator motor according to claim 9, wherein a plurality of the hollow sections are provided at intervals in the circumferential direction of the commutator.

13. The direct-current commutator motor according to claim 9, wherein the different material portion is the pigtail.

14. The direct-current commutator motor according to claim 13, wherein at least a front end portion of the pigtail on the commutator side is provided to extend in a direction in which the brush is pressed toward the commutator.

15. The direct-current commutator motor according to claim 14, wherein the hollow section and the front end portion of the pigtail are provided at intervals in a direction in which the brush is pressed toward the commutator.
